(19) United States
(12) Patent Application Publication
(10) Pub. No.: US 2003/0048397 A1
(43) Pub. Date: Mar. 13, 2003

(54) Backpanel structure of liquid crystal on silicon

(76) Inventors: Chin-Lung Hung, Hsinchu (TW); Charlie Han, Hsinchu Hsien (TW)

Correspondence Address: CHARLES C.H. WU & ASSOCIATES, Suite 710, 7700 IRVINE CENTER DRIVE, Irvine, CA, 92618-3043, US

(21) Appl. No.: 10/055,107

(22) Filed: Jan. 23, 2002

(30) Foreign Application Priority Data
Sep. 10, 2001 (TW) 90122320

(51) Int. Cl. G02F 1/1335

(52) U.S. Cl. 349/113

(57) ABSTRACT

A silicon backpanel structure of a LCOS is described. The present silicon back panel has a cell region and a routing/pad region, wherein the cell region of the silicon backpanel is arranged with a plurality of pixels and an alignment layer is disposed over the silicon backpanel, and the routing/pad region is arranged with a patterned trace and a plurality of routing/pads, and the routings/pads are electrically bonded to the pixels by means of the patterned trace. Furthermore, the patterned trace of the routing/pad regions is mounted with a break protective layer. This break protective layer protects the patterned trace of the routing/pad region from damage by the pressing of the upper transparent substrate in the subsequent breaking stage.

### CROSS-REFERENCE TO RELATED APPLICATION

This application claims the priority benefit of Taiwan application serial no. 90122320, filed Sep. 20, 2001

### BACKGROUND OF THE INVENTION

1. Field of the Invention

The present invention relates to a backpanel structure of LCOS (Liquid Crystal On Silicon), and in particular, a silicon backpanel of LCOS having a break protective layer, formed on the exposed routing/pad region of the silicon back panel, to prevent the silicon backpanel from being damaged by pressing of the upper transparent substrate in the breaking step of the fabrication procedures.

2. Description of the Prior Art

In recent years, LCD devices have become widely used in daily life. For instance, liquid crystal TVs, portable computers or LC monitors for desktop computers and liquid crystal projectors. The liquid crystal projector has become an indispensable tool for large size display. The core of the liquid crystal projector is the optical engine employed in projection. The optical engine essentially includes a light source, an optical element formed from a plurality of rhombic lens modules and a plurality of liquid crystal panels corresponding to each light path (R, G, & B). The above liquid crystal panel makes use of LCOS. LCOS is a reflective liquid crystal panel framed on a silicon backpanel. As LCOS is framed on the silicon back panel, small in volume and of fairly good resolution, it is commonly used in liquid crystal projectors, as it complies with the demand of liquid crystal projectors for small volume.

FIG. 1 is a structural schematic view of a conventional LCOS prior to a breaking step. In a silicon backpanel 100 of a conventional LCOS, a cell region 102 and a routing/pad region 104 are formed thereon. The top of the silicon backpanel 100 is arranged with an alignment layer 106, wherein the alignment layer 106 is located on the cell region 102 and the routing/pad region 104. The alignment layer 106 can also be only located on the cell region 102. Top of the routing/pad region 104 is arranged with patterned trace and a plurality of outer electrically bonded routing/pads 108. A sealant material 110 is provided around the cell region 102 and the sealant material 110 is provided with a transparent substrate 112 with ITO material. The sealant material 110 contains spacers having fixed diameter to ensure that the gap between the silicon backpanel 100 and the transparent substrate 112 will not vary as a result of the fabrication process. In conventional LCOS, after the transparent substrate 112 is mounted on the sealant material 110 and the silicon backpanel 100, the silicon backpanel 100 and the transparent substrate 112 are cut. The silicon backpanel 100 is cut by means of a wafer saw. In order to keep water from diffusing into the cell gap during the process of cutting with the wafer saw, the silicon backpanel 100 is cut only to a partial thickness. After that, each cell is broken apart by a breaking method.

FIG. 2 is the structural schematic view of LCOS after the breaking step. By design, the routing/pad region 104 of the silicon backpanel 100 must be exposed so as to facilitate electrical bonding to another carrier, for instance PCB by means of the routing/pad 108. Thus, the silicon backpanel 100 cutting line and the transparent substrate 112 cutting line are not on a same vertical line. As the silicon backpanel 100 cutting line and the transparent substrate 112 cutting line are not on the same vertical line, in the breaking process, the patterned trace on the routing/pad region 104 can be easily damaged by the pressing of the upper layer of the transparent substrate 112, in which case the cells cannot be used.

In the conventional breaking step, the cell easily becomes unusable due to damage from improper force exertion, and the yield of LCOS cannot be effectively controlled and the cost of production is high.

### SUMMARY OF THE INVENTION

Accordingly, it is an object of the present invention to provide a backpanel structure for LCOS that keeps the exposed routing/pad region 104 on the silicon backpanel from being damaged in the breaking step.

In order to achieve the above objective, it is an object of the present invention to provide a backpanel structure of LCOS. The present silicon back panel has a cell region and a routing/pad region. An alignment layer is disposed on the silicon backpanel, wherein the alignment layer can be located over the cell region and the routing/pad region, or can only be located over the cell region. The cell region of the silicon back panel is arranged with a plurality of pixels and an alignment layer covers the pixels. The routing/pad region is arranged with a patterned trace and a plurality of routing/pads, and the routings/pads are electrically bonded to the pixels by means of the patterned trace. Furthermore, the patterned trace of the routing/pad regions is mounted with a break protective layer. This break protective layer protects the patterned trace of the routing/pad region from becoming damaged by the pressing of the upper transparent substrate in the subsequent breaking step.

The arranged break protective layer on the present patterned trace can either cover a partial region of the patterned trace, the covered region, for instance, in the region commonly damaged by the upper transparent substrate in the subsequent breaking step, or the break protective layer can fully cover the distributed region of the patterned trace, protecting the patterned trace. The thickness of the break protective layer either equals the thickness of the sealant material (containing spacers), or is slightly lower than this thickness.

The break protective layer on the patterned trace of the present invention, for instance, could be a photoresist, commonly used in semiconductor fabrication, or a dielectric material, both of which are able to protect the patterned trace.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a structural schematic view of a conventional LCOS prior to breaking step.

FIG. 2 is a structural schematic view of a conventional LCOS after the breaking step.

FIG. 3 is a structural schematic view of the LCOS silicon back panel of a preferred embodiment in accordance with the present invention.

FIG. 4 is a structural schematic view of the LCOS silicon backpanel of a preferred embodiment prior to breaking step in accordance with the present invention.

FIG. 5 is a structural schematic view of the LCOS silicon backpanel of a preferred embodiment after the breaking step in accordance with the present invention.

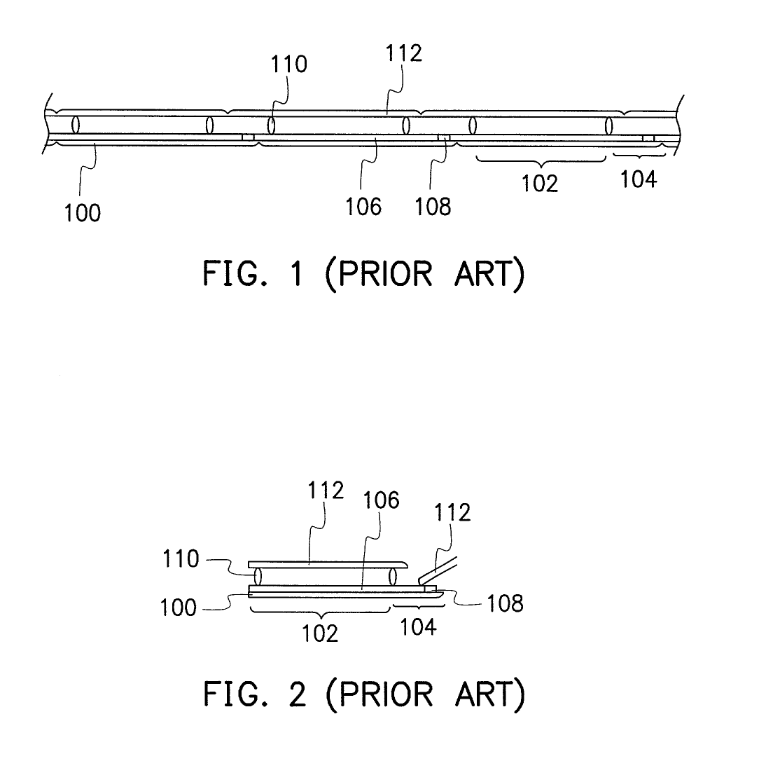

### DETAILED DESCRIPTION OF THE PREFERRED EMBODIMENT

Reference will now be made in detail to the present preferred embodiments of the invention, examples of which are illustrated in the accompanying drawings. Wherever possible, the same reference numbers are used in the drawings and the description to refer to the same or like parts.

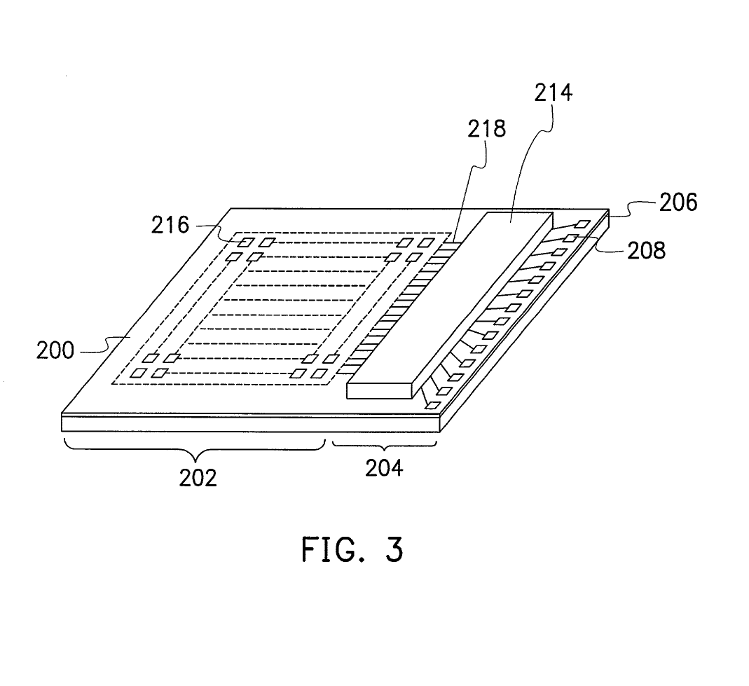

FIG. 3 is a structural schematic view of the LCOS silicon backpanel of a preferred embodiment in accordance with the present invention. The silicon backpanel 200 is divided into a cell region 202 and a routing/pad region 204, wherein the cell region 202 of the silicon backpanel 200 is arranged with, for example, a plurality of pixels 216 and an alignment layer 206 covering the pixels 216. The routing/pad region 204 is arranged, for example, with a patterned trace 218 and a plurality of routings/pads 208. The routing/pads 208 are electrically bonded to the pixels 216 by means of a patterned trace 218. The patterned trace 218 of the present routing/pad region 204 is arranged with a break protective layer 214. This break protective layer 214 is used to protect the patterned trace 218 on the routing/pad region 204 to keep the patterned trace 218 from being damaged by the upper transparent substrate (not shown) at the subsequent breaking step.

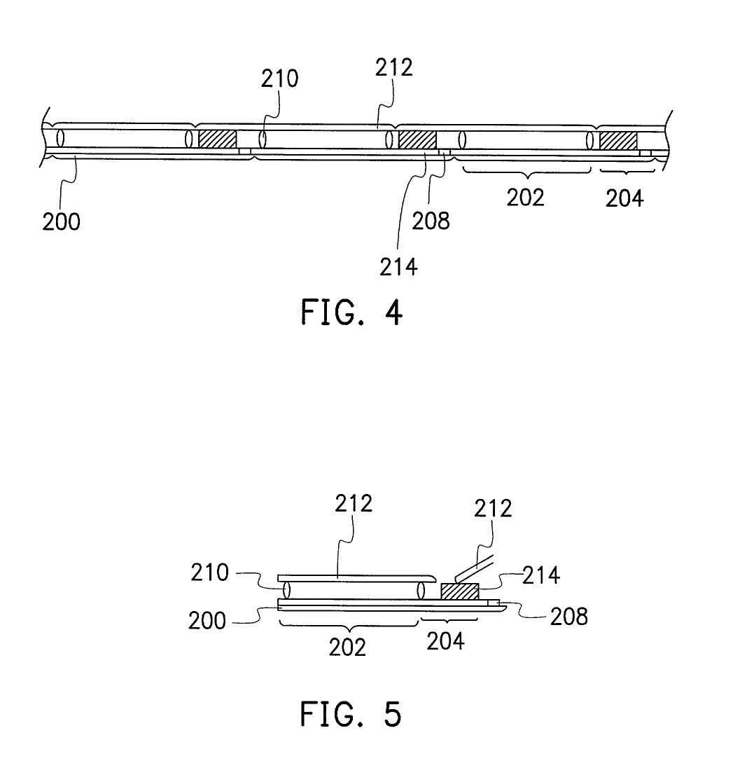

The material of the break protective layer 214, for instance, is a photoresist, commonly used in semiconductor fabrication, or is a dielectric material to protect the patterned trace 218, and the method of fabrication, for instance, is forming a photoresist on the silicon backpanel 200, and then forming a photomask, exposure, and imaging. On the routing/pad region 204, a patterned break protective layer 214 is formed. The patterned break protective layer 214, for instance, covers a partial region of the patterned trace 218, the covered region commonly damaged by the pressing of the upper transparent substrate (not shown) in the subsequent breaking step. The break protective layer 214 can also fully cover the patterned trace 218 region. Thus, the objective of protecting the patterned trace 218 is achieved. In addition, the thickness of the break protective layer 214 can be equal to or slightly lower than the thickness of the sealant material 210 (as shown in FIG. 4).

Generally, the thickness of the sealant material 210 is about between 1.5 μm and 5.0 μm. Thus, the thickness of the break protective layer 214 can be selected between 1.5 μm and 5.0 μm, depending on which kind of sealant material is to be chosen.

Next, as shown in FIG. 4, is a structural schematic view of LCOS of the preferred embodiment in accordance with the present invention. After the fabrication of the break protective layer 214 on the routing/pad region 204 is completed, a transparent substrate 212 is placed on the sealant material 210. This transparent substrate 212, for instance, is ITO material substrate. The sealant material 210 is formed between the silicon backpanel 200 and the transparent substrate 212. The transparent substrate 212 and the silicon backpanel 200 are adhered by means of the sealant material 210, wherein the mounting position of the sealant material 210 surrounds the cell region. The sealant material 210 is provided with, for instance, spacers of a fixed diameter so as to ensure the gap between the silicon backpanel 200 and the transparent substrate 212 does not have great variation. The diameter of the spacer can be selected, for example, between 1.5 μm and 5.0 μm. The size of this diameter directly affects the sealant material thickness.

After the transparent substrate 212 is adhered to the silicon backpanel 200, the transparent substrate 212 and the silicon backpanel 200 are cut. The silicon backpanel 200 is for instance cut with a wafer saw, and in order to avoid water being diffused into the cell gap, only a partial thickness of the silicon backpanel 200 is cut. After that, the individual cells are broken apart.

FIG. 5 shows a structural schematic view of the LCOS silicon backpanel of a preferred embodiment after the breaking step in accordance with the present invention. The routing/pad region 204 of the silicon backpanel 200, by design, has to be exposed to facilitate subsequent bonding electrically to another carrier, for instance, PCB, by means of the routing/pad 208. In accordance with the present invention, a break protective layer 214 is mounted on the patterned trace of the routing/pad region 204. In the breaking process, the exertion of force caused when the upper transparent substrate 212 presses downward will not easily damage the patterned trace of the routing/pad region 204. Thus, the yield of cells after the breaking process is increased.

In view of the above, the backpanel structure of LCOS of the present invention has the following advantages:

(1) The cell region of the backpanel structure of LCOS of the present invention being mounted with a break protective layer can protect the patterned trace on the cell region from being damaged in the breaking process.

(2) The cell region of the backpanel structure of LCOS of the present invention being mounted with a break protective layer can greatly improve the yield of the cells after the breaking process and can greatly lower the cost of production.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back panel structure of liquid crystal on silicon (LCOS) comprising
a substrate having a cell region and a routing/pad region, wherein the cell region is arranged with a plurality of pixels, and the routing/pad region is arranged with a patterned trace and a plurality of routing/pads, and the routings/pads are electrically bonded to the pixels by means of the patterned trace;
an alignment layer, disposed over the substrate; and
a break protective layer, arranged on the alignment layer over the routing/pad region.

2. The backpanel structure of claim 1, wherein the substrate is a silicon substrate.

3. The backpanel structure of claim 1, wherein the break protective layer is a photoresist.

4. The backpanel structure of claim 1, wherein the break protective layer is a dielectric layer.

5. A backpanel structure of liquid crystal on silicon (LCOS), comprising
a substrate, having a cell region and a mounting/pad region;
an alignment layer, disposed over the substrate; and
a break protective layer, arranged on the alignment layer over the routing/pad region.

6. The backpanel structure of claim 5, wherein the substrate is a silicon substrate.

7. The backpanel structure of claim 5, wherein the cell region of the substrate is arranged with a plurality of pixels.

8. The backpanel structure of claim 5, wherein the routing/pad region is arranged with a patterned trace and a plurality of routing/pads and the routing/pads are electrically bonded to the pixels through the patterned trace.

9. The backpanel structure of claim 5, wherein the break protective layer is arranged on the patterned trace of the routing/pad region.

10. The backpanel structure of claim 5, wherein the break protective layer is a photoresist.

11. The backpanel structure of claim 5, wherein the break protective layer is a dielectric layer.

12. A liquid crystal on silicon (LCOS) cell structure, comprising;
a silicon back panel having a cell region and a routing/pad region, wherein the routing/pad region is arranged with a break protective layer;
an alignment layer disposed over the silicon back panel;
a transparent substrate being mounted on the top of the cell region to expose the routing/pad region;
a sealant material mounted between the silicon backpanel and the transparent substrate; and
a liquid crystal layer arranged at the space formed by the silicon backpanel, the transparent substrate and the sealant material.

13. The LCOS cell structure of claim 12, wherein the cell region is arranged with a plurality of pixels and an alignment layer.

14 The LCOS cell structure of claim 12, wherein the routing/pad region is arranged with a patterned trace and a plurality of routings/pads, and the routings/pads are electrically bonded to the pixels by means of the patterned trace.

15. The LCOS cell structure of claim 12, wherein the break protective layer is arranged on the patterned trace of the routing/pad region.

16. The LCOS cell structure of claim 12, wherein the break protective layer is a photoresist.

17. The LCOS cell structure of claim 12, wherein the break protective layer is a dielectric.
